(19) United States
(12) Patent Application Publication
(10) Pub. No.: US 2018/0356976 A1
(43) Pub. Date: Dec. 13, 2018

(54) Electronic Device That Reduces Unauthorized Use by Third Person

(71) Applicant: Kyocera Document Solutions Inc., Osaka (JP)

(72) Inventor: Koichi Morita, Osaka (JP)

(21) Appl. No.: 16/002,352

(22) Filed: Jun. 7, 2018

(30) Foreign Application Priority Data
Jun. 7, 2017 (JP) 2017-112519

(51) Int. Cl. G06F 3/0488; G06F 21/36

(52) U.S. Cl. CPC G06F 3/04886; G06F 21/36

(57) ABSTRACT

An electronic device includes a touch panel, a control unit, and a storage device. The storage device preliminarily stores password information and keypad arrangement information. The keypad arrangement information includes initial arrangement information and authentication arrangement information. The control unit obtains first input information indicating an arrangement of the plurality of keys where positions of at least two keys included in the plurality of keys are exchanged through the panel operation. The control unit obtains second input information indicating a combination of characters corresponding to the keys selected through the panel operation among the plurality of keys. The control unit executes an arrangement determination process and a password determination process, the arrangement determination process determining whether the first input information matches the authentication arrangement information or not, the password determination process determining whether the second input information matches the password information or not.

### INCORPORATION BY REFERENCE

This application is based upon, and claims the benefit of priority from, corresponding Japanese Patent Application No. 2017-112519 filed in the Japan Patent Office on Jun. 7, 2017, the entire contents of which are incorporated herein by reference.

### BACKGROUND

Unless otherwise indicated herein, the description in this section is not prior art to the claims in this application and is not admitted to be prior art by inclusion in this section.

There is proposed a numeric keypad operation display device that displays a numeric keypad to be used for inputting a PIN code on a touch panel. Specifically, this numeric keypad operation display device includes the touch panel and a controller. The controller controls displaying the numeric keypad by the touch panel. Specifically, the controller selects one key-arrangement pattern from a plurality of key-arrangement patterns every time an operator changes. This changes an arrangement pattern of the numeric keypad displayed on the touch panel every time an operator changes.

### SUMMARY

An electronic device according to one aspect of the disclosure includes a touch panel, a control unit, and a storage device. The touch panel displays an authentication process screen including a plurality of keys to accept a panel operation from a user. The plurality of keys are used for inputting a password. The control unit displays the authentication process screen on the touch panel to ensure exchanging positions of the plurality of keys through the panel operation. The storage device preliminarily stores password information indicating the password and keypad arrangement information indicating an arrangement of the plurality of keys. The keypad arrangement information includes initial arrangement information indicating an initial arrangement and authentication arrangement information indicating an authentication arrangement. The initial arrangement information indicates an arrangement of the plurality of keys at a time when a display of the authentication process screen starts on the touch panel. The authentication arrangement information indicates an arrangement of the plurality of keys determined preliminarily by a user. The control unit obtains first input information indicating an arrangement of the plurality of keys where positions of at least two keys included in the plurality of keys are exchanged through the panel operation. The control unit obtains second input information indicating a combination of characters corresponding to the keys selected through the panel operation among the plurality of keys. The control unit executes an arrangement determination process and a password determination process, the arrangement determination process determining whether the first input information matches the authentication arrangement information or not, the password determination process determining whether the second input information matches the password information or not.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an electronic device according to one embodiment of the disclosure.

FIG. 2 illustrates an exemplary authentication process screen according to the one embodiment.

FIG. 3 illustrates a configuration of the electronic device according to the one embodiment.

FIGS. 4A and 4B illustrate exemplary change operations of a numeric keypad arrangement according to the one embodiment.

FIG. 5 illustrates an exemplary numeric keypad arrangement according to the one embodiment after the change operations.

FIG. 6A illustrates an exemplary authentication arrangement according to the one embodiment.

FIG. 6B illustrates another example of the authentication arrangement according to the one embodiment.

FIG. 7 illustrates an exemplary first error screen according to the one embodiment.

FIG. 8 illustrates an exemplary input operation of a PIN code according to the one embodiment.

FIG. 9 illustrates an exemplary second error screen according to the one embodiment.

FIG. 10 illustrates an arrangement determination process according to the one embodiment.

FIG. 11 illustrates a PIN code determination process according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of an electronic device 1 according to the disclosure with reference to the drawings. In the drawings, identical reference numerals are used to the identical or corresponding parts not to repeat explanations.

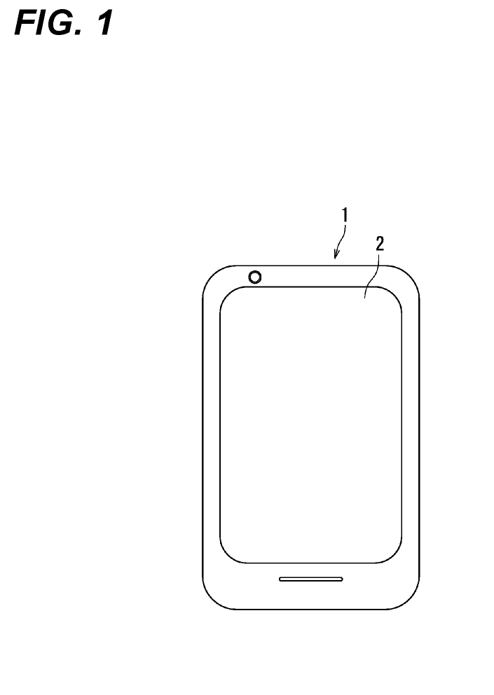

First, with reference to FIG. 1, the following describes the electronic device 1 according to the embodiment of the disclosure. FIG. 1 illustrates the electronic device 1 according to the embodiment. In the embodiment, the electronic device 1 is a smartphone.

As illustrated in FIG. 1, the electronic device 1 includes a touch panel 2. The touch panel 2 accepts a panel operation from a user.

The electronic device 1 according to the embodiment executes an authentication process. When the authentication process starts, an authentication process screen S is displayed on the touch panel 2.

The authentication process starts, for example, when a power supply status of the electronic device 1 changes from an off-state into an on-state. Alternatively, in the case where the electronic device 1 is in a lock state, the authentication process starts when, for example, the user's finger, or a stylus pen touches, for example, the touch panel 2. When the electronic device 1 is in the lock state, the user cannot use functions of the electronic device 1. On the other hand, when the authentication process succeeds to unlock the lock state of the electronic device 1, the user can use the functions of the electronic device 1.

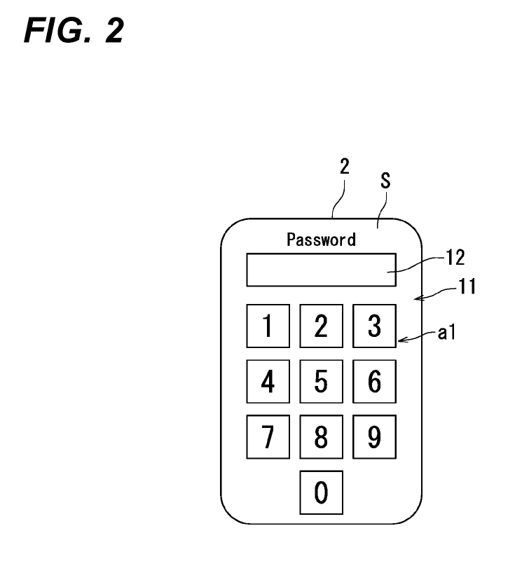

Then, with reference to FIG. 2, the following describes the authentication process screen S according to the embodiment. FIG. 2 illustrates an exemplary authentication process screen S according to the embodiment.

As illustrated in FIG. 2, the authentication process screen S includes a numeric keypad 11 and a password entry field 12. In the embodiment, a password is a PIN code generated from a combination of a plurality of numerals.

The numeric keypad 11 is used for inputting a PIN code. The numeric keypad 11 includes a plurality of rectangular-shaped keys. Specifically, the numeric keypad 11 includes numeric keys corresponding to respective numerals of “0” to “9.” In the following, the numeric key corresponding to the numeral of “0” may be referred to as a “0” key. Similarly, the numeric keys corresponding to the numerals of “1” to “9” may be referred to as a “1” key to a “9” key, respectively.

The “1” key to the “9” key are arranged in three rows and three columns, and the “0” key is located below the “8” key. Specifically, in the left row, from the top to the bottom, the “1” key, the “4” key, and the “7” key are arranged in this order. In the middle row, from the top to the bottom, the “2” key, the “5” key, the “8” key, and the “0” key are arranged in this order. In the right row, from the top to the bottom, the “3” key, the “6” key, and the “9” key are arranged in this order. In the following, an arrangement of the plurality of numeric keys in the numeric keypad 11 is referred to as a “numeric keypad arrangement.” The numeric keypad arrangement illustrated in FIG. 2 is referred to as an “initial arrangement a1.” The initial arrangement a1 denotes an arrangement of the plurality of numeric keys at the time when displaying the authentication process screen S starts. In other words, the initial arrangement a1 denotes respective initial positions of the plurality of numeric keys.

The respective positions of the plurality of numeric keys, which are included in the numeric keypad 11, are configured to be exchanged. In other words, the numeric keypad arrangement is changeable. In the embodiment, the information indicating a numeric keypad arrangement (hereinafter referred to as numeric keypad arrangement information) is used for the authentication process.

When the user selects any of the plurality of numeric keys multiple times (a predetermined number of times) through the panel operation, the password entry field 12 displays input number information (exemplary second input information). The input number information denotes a numeric string corresponding to the selected numeric keys. The user can set a non-display of the input number information. When the non-display of the input number information is set, the password entry field 12 displays “*” (asterisk) instead of the input number information. In the embodiment, the input number information is used for the authentication process.

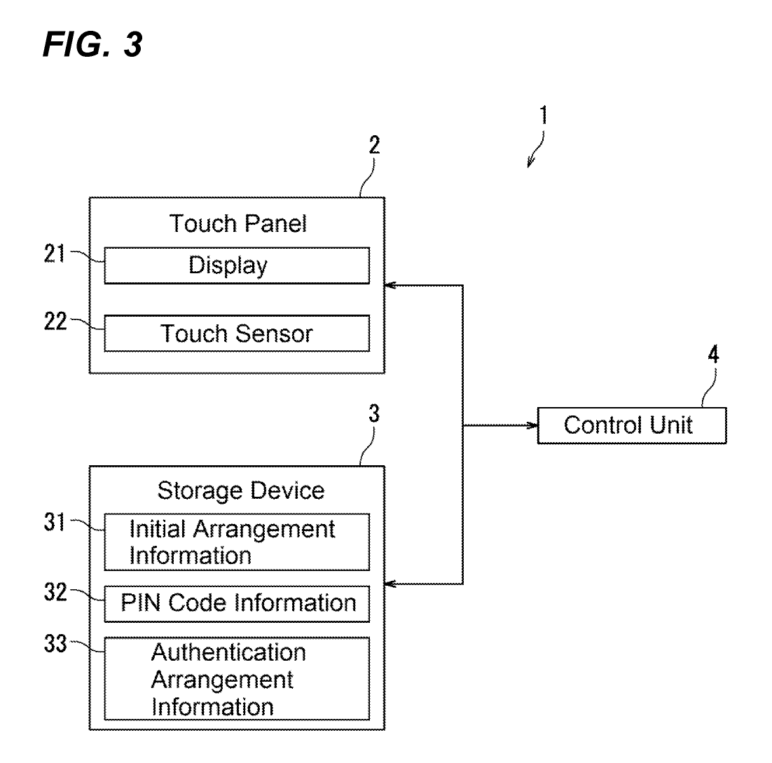

Then, with reference to FIG. 3, the following describes a configuration of the electronic device 1 according to the embodiment. FIG. 3 illustrates the configuration of the electronic device 1 according to the embodiment.

As illustrated in FIG. 3, the electronic device 1 includes a storage device 3 and a control unit 4 in addition to the touch panel 2.

The touch panel 2 includes a display 21 and a touch sensor 22. The display 21 includes, for example, a liquid crystal display or an organic electro-luminescence display. The touch sensor 22 includes, for example, a touch sensor using resistance film method.

The display 21 has a display surface. The display 21 displays, for example, results of various kinds of processes by the control unit 4 on the display surface.

The touch sensor 22 has a touch surface. In the embodiment, the touch surface is located above the display surface.

When the panel operation on the touch surface is detected (the panel operation is accepted), the touch sensor 22 generates a signal indicating the position at which the panel operation is detected. In the embodiment, the panel operation includes a hold operation (an exemplary first panel operation), a release operation (an exemplary second panel operation), and a tap operation (an exemplary third panel operation).

The storage device 3 typically includes a semiconductor memory. Specifically, the storage device 3 is constituted of a random-access memory (RAM), and a read-only memory (ROM). The storage device 3 stores a control program for controlling operations of the respective units in the electronic device 1. The control program is executed by the control unit 4. The storage device 3 may include a storage device, such as a hard disk drive (HDD) and a solid-state drive (SSD).

In the embodiment, the storage device 3 preliminarily stores initial arrangement information 31 indicating the initial arrangement a1, which is described with reference to FIG. 2. The storage device 3 stores: PIN code information 32 (exemplary password information) indicating a PIN code; and authentication arrangement information 33 indicating a numeric keypad arrangement (hereinafter referred to as an authentication arrangement) that is used for authentication. The user preliminarily stores the PIN code information 32 and the authentication arrangement information 33 in the storage device 3.

The control unit 4 is constituted of a processor, such as a central processing unit (CPU). The control unit 4 executes the control program stored in the storage device 3 to control the operations of the respective units in the electronic device 1.

The control unit 4 receives the signal generated by the touch sensor 22. On the basis of the signal received from the touch sensor 22, the control unit 4 determines the numeric key corresponding to the position at which the touch sensor 22 has detected the panel operation. This causes the control unit 4 to obtain information indicating the numeral corresponding to the numeric key selected through the panel operation.

On the basis of the signal received from the touch sensor 22, the control unit 4 determines that a type of the panel operation is which of the hold operation, the release operation, or the tap operation. The hold operation means an operation where a period of the touching of the touch surface lasts for equal to or more than a specified period. The release operation means an operation that releases the touching of the touch surface. The tap operation means an operation where a period of the touching of the touch surface is less than a specified period. The specified period is a preliminarily set period, and is, for example, two seconds.

In the embodiment, the control unit 4 executes the authentication process. The authentication process includes an arrangement determination process and a PIN code determination process (an exemplary password determination process).

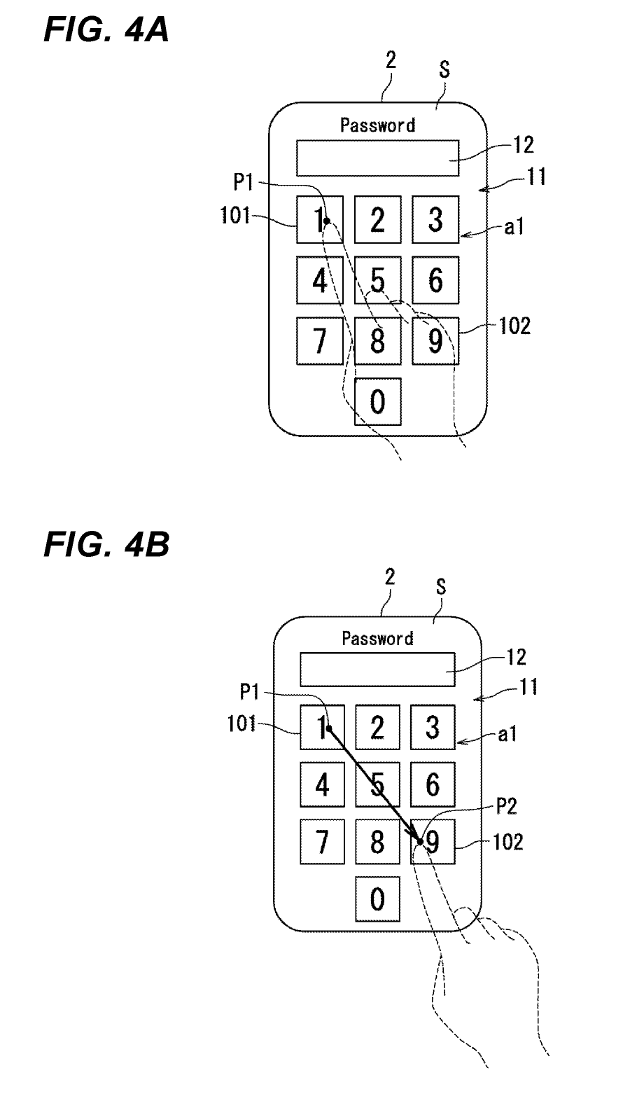

Then, with reference to FIGS. 4A to 7, the following describes the arrangement determination process according to the embodiment.

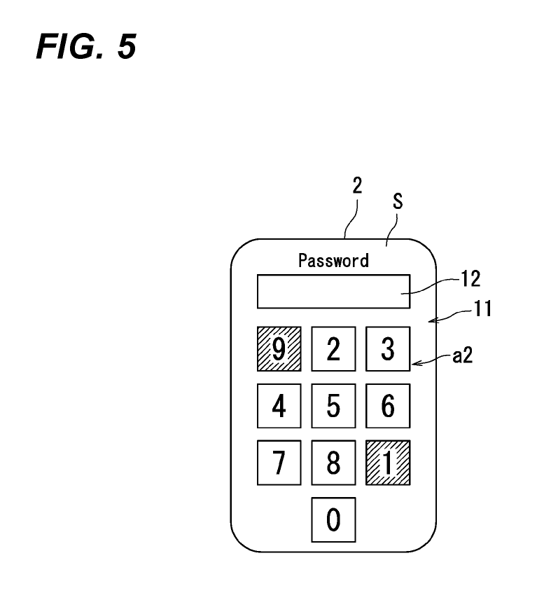

First, with reference to FIGS. 4A to 5, the following describes change operations of the numeric keypad arrangement according to the embodiment. The user can change the numeric keypad arrangement through the panel operation. Specifically, the positions of at least two numeric keys can be exchanged. As exemplary change operations of the numeric keypad arrangement, FIGS. 4A to 5 illustrate operations where the position of the “1” key and the position of the “9” key are exchanged.

FIGS. 4A and 4B illustrate the exemplary change operations of the numeric keypad arrangement according to the embodiment. The numeric keypad arrangement illustrated in FIGS. 4A and 4B is the initial arrangement a1. FIG. 5 illustrates an exemplary numeric keypad arrangement according to the embodiment after the change operations. FIGS. 4A and 4B illustrate panel operations that are performed with the finger of the user himself/herself, as examples.

As illustrated in FIG. 4A, when the user performs the hold operation at a first position P1 on the touch surface, the control unit 4 obtains the numeric key on which the hold operation has been performed as a hold key 101 (an exemplary first key). In the example illustrated in FIG. 4A, the first position P1 is included in the display area of the “1” key. Thus, the control unit 4 obtains the “1” key as the hold key 101.

Next, as illustrated in FIG. 4B, when the user performs the release operation after moving the user's finger to a second position P2 (a drag operation) while the user maintains the hold operation on the “1” key (while touching the touch surface), the control unit 4 obtains the numeric key on which the release operation has been performed as a release key 102 (an exemplary second key). In the example illustrated in FIG. 4B, the second position P2 is included in the display area of the “9” key. Thus, the control unit 4 obtains the “9” key as the release key 102.

When obtaining the release key 102, the control unit 4 causes the touch panel 2 to display the plurality of numeric keys in the arrangement where the positions of the hold key 101 and the release key 102 are exchanged. This exchanges the positions of the “9” key and the “1” key, as illustrated in FIG. 5. In the following, the numeric keypad arrangement where positions of at least two numeric keys are exchanged from an initial position is referred to as an “input arrangement a2.” The control unit 4 temporarily stores the information indicating the input arrangement a2 as input arrangement information (exemplary first input information) in the storage device 3, which is described with reference to FIG. 3.

The input arrangement information is used for the arrangement determination process. Specifically, the control unit 4 determines whether the input arrangement a2 matches the authentication arrangement indicated by the authentication arrangement information 33 or not. The determination whether the input arrangement a2 matches the authentication arrangement or not is determined by, for example, pattern matching.

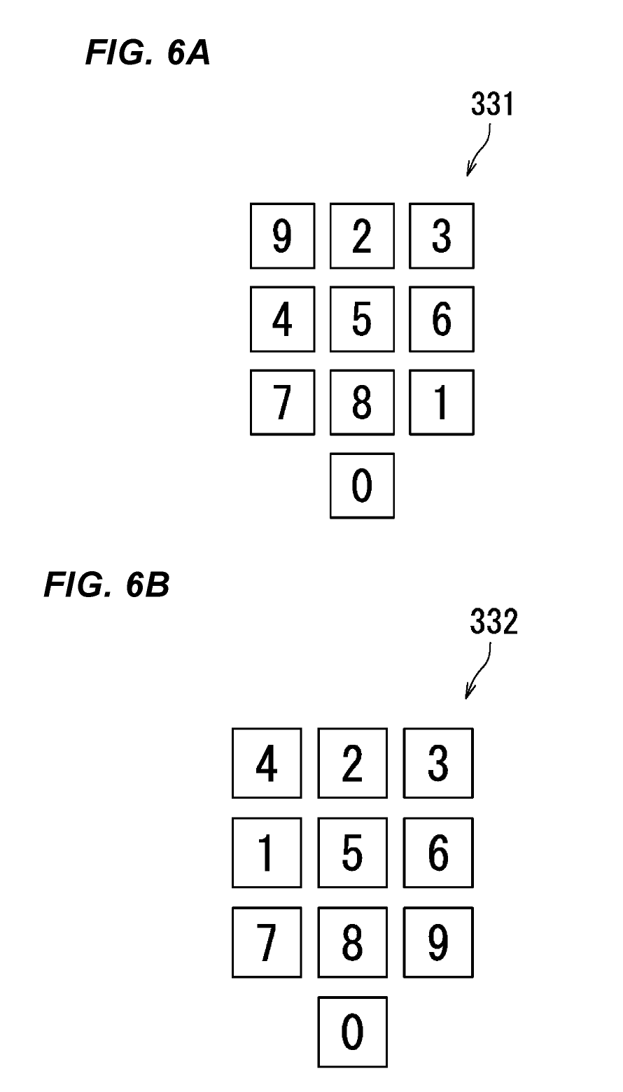

Then, with reference to FIGS. 6A and 6B, the following describes the arrangement determination process according to the embodiment.

FIG. 6A illustrates an exemplary authentication arrangement according to the embodiment. FIG. 6B illustrates another example of the authentication arrangement according to the embodiment.

In an authentication arrangement 331 illustrated in FIG. 6A, compared with the initial arrangement a1, which is described with reference to FIG. 2, the positions of the “1” key and the “9” key are exchanged. That is, the authentication arrangement 331 matches the input arrangement a2 illustrated in FIG. 5. Thus, when the input arrangement information indicates the input arrangement a2 illustrated in FIG. 5, the control unit 4 determines that the input arrangement information matches the authentication arrangement information 33 (the authentication arrangement 331). In other words, the arrangement determination process has succeeded.

Meanwhile, in an authentication arrangement 332 illustrated in FIG. 6B, compared with the initial arrangement a1, the positions of the “1” key and the “4” key are exchanged. Thus, when the input arrangement information indicates the input arrangement a2 illustrated in FIG. 5, the control unit 4 determines that the input arrangement information does not match the authentication arrangement information 33 (the authentication arrangement 332). In other words, the arrangement determination process has failed. When the arrangement determination process has been determined to be failed, the control unit 4 reports an error. In the embodiment, when the arrangement determination process has been determined to be failed, the control unit 4 causes the touch panel 2 to display a first error screen E1. The control unit 4 may lock an account instead of causing the touch panel 2 to display the first error screen E1. When the account is locked, even when the input arrangement information matches the authentication arrangement information 33, the user cannot use the functions of the electronic device 1. This reduces the unauthorized use of the electronic device 1 by a third person.

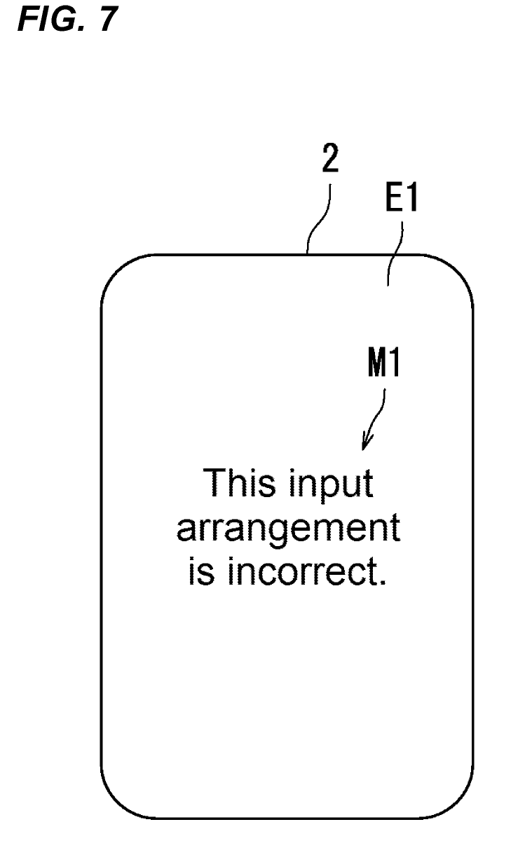

FIG. 7 illustrates an exemplary first error screen E1 according to the embodiment. The first error screen E1 includes a first error message M1. The first error message M1 indicates the fact that the arrangement determination process has failed. For example, the first error message M1 includes the message indicating that “This input arrangement is incorrect.” The control unit 4 may notify, for example, an administrator by the mail including the first error message M1 instead of causing the touch panel 2 to display the first error screen E1.

Next, with reference FIGS. 1 to 9, the following describes the PIN code determination process according to the embodiment.

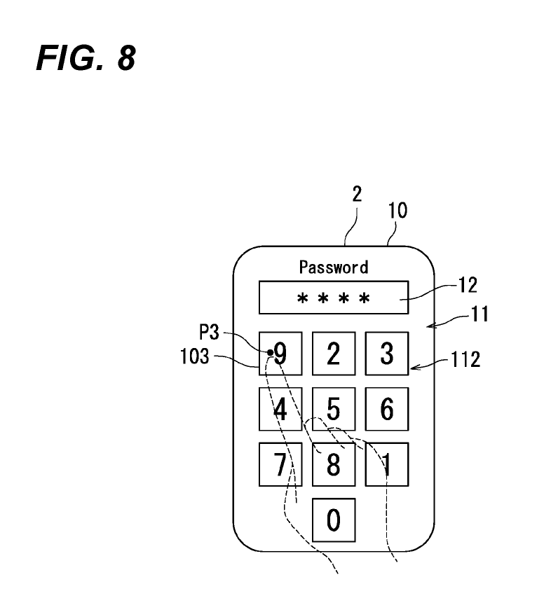

First, with reference to FIG. 8, the following describes an input operation of the PIN code according to the embodiment. The user can input the PIN code through the panel operation. Specifically, when inputting the PIN code, the user repeats the panel operation that selects any of the numeric keys from the numeric keypad 11 a predetermined number of times.

FIG. 8 illustrates an exemplary input operation of the PIN code according to the embodiment. As an example of the input operation of the PIN code, FIG. 8 illustrates the operation where the “9” key is selected. FIG. 8 illustrates a panel operation that is performed with the finger of the user himself/herself, as an example.

As illustrated in FIG. 8, the user performs the tap operation at a third position P3 on the touch surface. The third position P3 is included in the display area of the “9” key. Thus, the control unit 4 obtains the “9” key as the numeric key selected through the tap operation. In the following, the numeric key selected through the tap operation is referred to as a tap key 103 (an exemplary third key). In the example illustrated in FIG. 8, the input number information is configured to be hidden. When obtaining the tap key 103, the control unit 4 causes the password entry field 12 to display “*.”

In the embodiment, the PIN code is set to four digits. Thus, the user repeats selecting a numeric key through the tap operation four times to input the PIN code. The control unit 4 sequentially obtains the numeric keys selected through the tap operations as tap keys 103. The control unit 4 sequentially determines the numeral corresponding to the tap key 103. The control unit 4 combines the numerals corresponding to the tap keys 103 in the order of obtaining the tap key 103 to obtain the input number information. The input number information is temporarily stored in the storage device 3, which is described with reference to FIG. 3, to be used for the PIN code determination process. Specifically, when obtaining the input number information, the control unit 4 determines whether the input number information matches the PIN code information 32, which is described with reference to FIG. 3, or not.

When the input number information has been determined to match the PIN code information 32, the control unit 4 transitions a state of the electronic device 1 into an unlock state. On the other hand, when the input number information has been determined not to match the PIN code information 32 (the PIN code determination process has failed), the control unit 4 reports an error. In the embodiment, when the input number information has been determined not to match the PIN code information 32, the control unit 4 causes the touch panel 2 to display a second error screen E2. The control unit 4 may lock an account instead of causing the touch panel 2 to display the second error screen E2. When the account is locked, even when the input number information matches the PIN code information 32, the user cannot use the functions of the electronic device 1. This reduces the unauthorized use of the electronic device 1 by a third person.

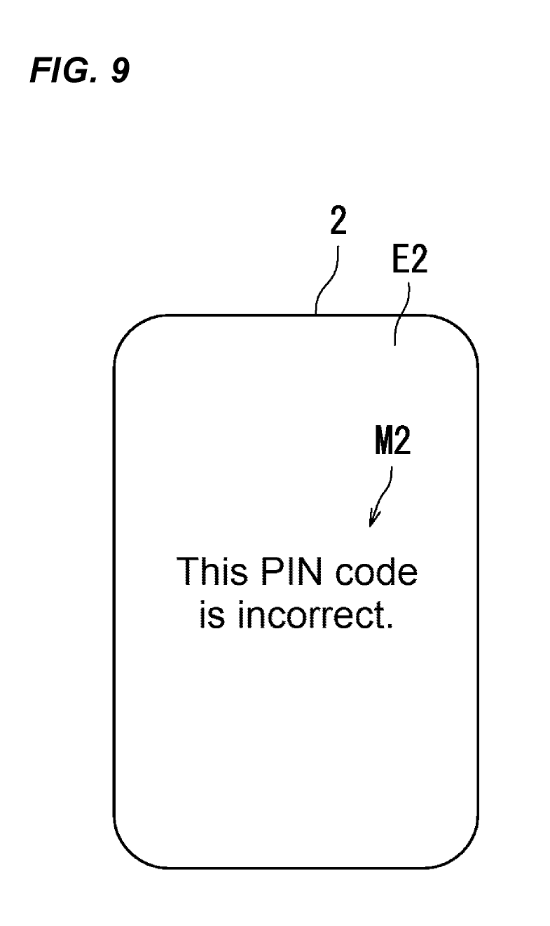

FIG. 9 illustrates an exemplary second error screen E2 according to the embodiment of the disclosure. The second error screen E2 includes a second error message M2. The second error message M2 indicates the fact that the PIN code determination process has failed. For example, the second error message M2 includes the message indicating that “This PIN code is incorrect.” The control unit 4 may notify, for example, an administrator by the mail including the second error message M2 instead of causing the touch panel 2 to display the second error screen E2.

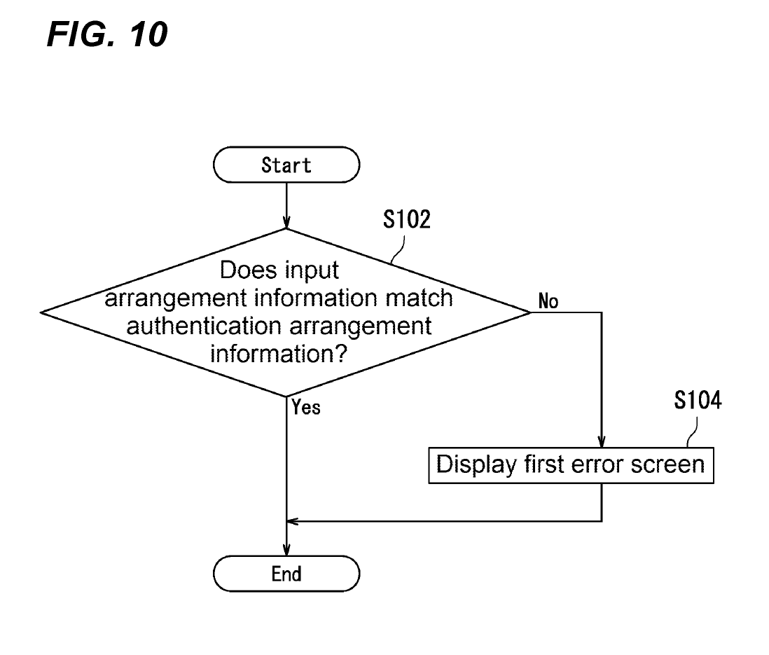

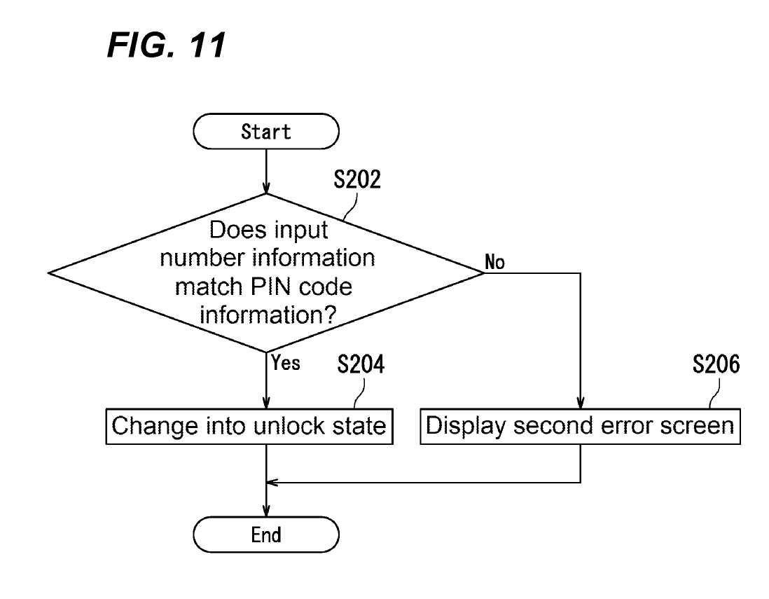

Then, with reference to FIGS. 10 and 11, the following describes the flows of the arrangement determination process and the PIN code determination process according to the embodiment. FIG. 10 illustrates the arrangement determination process according to the embodiment. In the embodiment, the arrangement determination process starts when the control unit 4 obtains the input number information.

As illustrated in FIG. 10, the control unit 4 determines whether the input arrangement information matches the authentication arrangement information 33 or not (Step S102). When the input arrangement information has been determined to match the authentication arrangement information 33 (Step S102: Yes), the control unit 4 terminates the arrangement determination process. On the other hand, when the input arrangement information has been determined not to match the authentication arrangement information 33 (Step S102: No), the control unit 4 causes the touch panel 2 to display the first error screen E1 (see FIG. 7) to terminate the arrangement determination process (Step S104).

FIG. 11 illustrates the PIN code determination process according to the embodiment of the disclosure. In the embodiment, the PIN code determination process starts when the control unit 4 determines that the input arrangement information matches the authentication arrangement information 33 (Step S102 in FIG. 10: Yes).

As illustrated in FIG. 11, the control unit 4 determines whether the input number information matches the PIN code information 32 or not (Step S202). When the input number information has been determined to match the PIN code information 32 (Step S202: Yes), the control unit 4 sets the electronic device 1 into the unlock state (Step S204) to terminate the PIN code determination process. On the other hand, when the input number information has been determined not to match the PIN code information 32 (Step S202: No), the control unit 4 causes the touch panel 2 to display the second error screen E2 (see FIG. 9) to terminate the PIN code determination process (Step S206).

The above has described the embodiment of the disclosure. With the embodiment, the control unit 4 executes the arrangement determination process in addition to the PIN code determination process. This reduces the unauthorized use of the electronic device 1 by a third person even if the PIN code is leaked.

While in the embodiment the case where the positions of the two numeric keys are exchanged has been described, the number of numeric keys to be exchanged is not limited to two. For example, positions of three or more numeric keys may be exchanged.

While in the embodiment the configuration where the plurality of numeric keys are used to input a password has been described, the keys to be used for inputting the password are not limited to numeric keys. For example, the keys to be used for inputting the password may be alphabet keys. Alternatively, they may be symbol keys, such as “*.”

While in the embodiment the case where the panel operation includes the tap operation, the hold operation, and the release operation has been described as an example, it is only necessary that the panel operation is an operation that ensures instructing the control unit 4 for the selection of the numeric keys and the exchanging of the positions of the numeric keys.

While in the embodiment the case where the numeric keypad arrangement is changed through the hold operation and the release operation has been described as an example, the method for changing the numeric keypad arrangement is not limited to this. For example, the first key and the second key may be obtained through an operation (a tap operation) where the touch panel 2 is touched with strength different from the tap operation.

While in the embodiment the control unit 4 executes the arrangement determination process before starting the PIN code determination process, the control unit 4 may execute the PIN code determination process before starting the arrangement determination process.

While in the embodiment the user inputs the input number information after inputting the input arrangement information, the user may input the input arrangement information after inputting the input number information. In this case, the authentication process screen further includes a key, such as an “Enter” key, that indicates terminating an input of input arrangement information.

For example, while in the embodiment of the disclosure the configuration where the numeric keypad 11 has rectangular-shaped numeric keys has been described, the numeric keypad 11 may have, for example, circular numeric keys.

While in the embodiment of the disclosure the case where the disclosure is applied to a smartphone has been described as an example, the disclosure is also applicable to, for example, an electronic device other than a smartphone. Specifically, the disclosure is applied to an electronic device including a touch panel. For example, the disclosure is also applicable to an electronic device such as a tablet terminal.

The disclosure is useful for an electronic device field.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device comprising:
a touch panel that displays an authentication process screen including a plurality of keys to accept a panel operation from a user, the plurality of keys being used for inputting a password;
a control unit that displays the authentication process screen on the touch panel to ensure exchanging positions of the plurality of keys through the panel operation; and
a storage device that preliminarily stores password information indicating the password and keypad arrangement information indicating an arrangement of the plurality of keys; wherein
the keypad arrangement information includes initial arrangement information indicating an initial arrangement and authentication arrangement information indicating an authentication arrangement,
the initial arrangement information indicates an arrangement of the plurality of keys at a time when a display of the authentication process screen starts on the touch panel,
the authentication arrangement information indicates an arrangement of the plurality of keys determined preliminarily by a user,
the control unit obtains first input information indicating an arrangement of the plurality of keys where positions of at least two keys included in the plurality of keys are exchanged through the panel operation,
the control unit obtains second input information indicating a combination of characters corresponding to the keys selected through the panel operation among the plurality of keys, and
the control unit executes an arrangement determination process and a password determination process, the arrangement determination process determining whether the first input information matches the authentication arrangement information or not, the password determination process determining whether the second input information matches the password information or not.

2. The electronic device according to claim 1, wherein the control unit executes the arrangement determination process before starting the password determination process.

3. The electronic device according to claim 1, wherein:
when the control unit determines that the first input information matches the authentication arrangement information, the control unit executes the password determination process; and
when the control unit determines that the first input information does not match the authentication arrangement information, the control unit reports an error.

4. The electronic device according to claim 3, wherein:
when the control unit determines that the second input information matches the password information, the control unit transitions into a state that enables the user to use the electronic device; and
when the control unit determines that the second input information does not match the password information, the control unit reports an error.

5. The electronic device according to claim 1, wherein:
the panel operation includes a first panel operation, a second panel operation, and a third panel operation;
the control unit obtains a key corresponding to a position at which the first panel operation has been detected among the plurality of keys as a first key;
the control unit obtains a key corresponding to a position at which the second panel operation has been detected among the plurality of keys as a second key;
the control unit obtains a key corresponding to a position at which the third panel operation has been detected among the plurality of keys as a third key;
the first panel operation means an operation where the touching of the touch panel lasts for equal to or more than a specified period;
the second panel operation means an operation that releases the touching of the touch panel;
the third panel operation means an operation where a period of the touching of the touch panel is less than a specified period;
the control unit exchanges positions of the first key and the second key to obtain the first input information; and
the control unit combines the third keys in an order of obtaining the third keys to obtain the second input information.
